(19) United States
(12) Patent Application Publication
(10) Pub. No.: US 2023/0129654 A1
(43) Pub. Date: Apr. 27, 2023

(54) DRIVE UNIT FOR A SELF-DRIVING VEHICLE, SELF-DRIVING VEHICLE, SUPPORT STRUCTURE FOR SELF-DRIVING VEHICLES, AND TRANSPORT SYSTEM

(71) Applicant: Robert Bosch GmbH, Stuttgart (DE)

(72) Inventors: Adrian Heinrich Sichau, Holzgerlingen (DE); Bernd Stuke, Leonberg (DE); Felix Jaegle, Ditzingen (DE); Gael Le Hen, Ludwigsburg (DE); Olaf Ohlhafer, Erligheim (DE)

(21) Appl. No.: 17/801,598

(22) PCT Filed: Mar. 1, 2021
(86) PCT No.: PCT/EP2021/055005

§ 371 Date: Aug. 23, 2022

(30) Foreign Application Priority Data
Mar. 2, 2020 (DE) 10 2020 202 616.5

(51) Int. Cl. B61B 3/02; B60L 50/60

(52) U.S. Cl. CPC B61B 3/02; B60L 50/60

(57) ABSTRACT

A drive unit for a self-driving vehicle of an elevated-track-type support structure. The drive unit has at least one electric motor for moving the drive unit along the support structure, the at least one electric motor being able to be at least indirectly driven indirectly with the aid of a first energy supply, and the first energy supply having at least one contact element, which is developed to interact with an electrical conductor immovably situated on the support structure.

### FIELD

The present invention relates to a drive unit for a self-driving vehicle of an elevated-track-type support structure. Within the framework of the present invention, a self-driving vehicle is understood as a vehicle that is able to be moved along the support structure with the aid of the drive unit, i.e., with the aid of its own drive. Possibilities include both autonomously driving vehicles, i.e., driverless vehicles, and cars that are controlled by a driver or operator. The vehicle may typically be used to transport persons or freight. In addition, the present invention relates to a self-driving car having a drive unit according to the present invention, a support structure for a drive unit developed according to the present invention or a corresponding self-driving vehicle, and to a transport system.

### BACKGROUND INFORMATION

A drive unit for a self-propelled carriage of an elevated track-type support structure is described in U.S. Patent Application Publication No. US 2017/0313328 A1. This drive device is characterized in that it can be used to reach different stations or locations on a route system in an autonomous manner, for which purpose the drive unit is equipped with an electric motor for driving the self-propelled carriage. In the cited document, the energy supply of the drive unit is implemented with the aid of a separate electrical conductor, which is developed or situated in the cross-section of the support cable as a component of the support structure. Moreover, to reach different route networks or driving routes, according to this document, the drive unit with the self-propelled carriage is allowed to enter the region of elements resembling track switches, which are typically located in the vicinity of points of intersection of the route network in order to enable travel along different driving routes.

### SUMMARY

A drive unit for a self-driving vehicle of an elevated-track-type support structure according to the present invention has the advantage that, independently of an (external) energy supply, formed by a support structure, for the drive unit of the electric motor, it allows for an autonomous operation of the drive unit or an autonomous movement of the self-driving vehicle along a driving route even without an external energy supply. This has the advantage that a self-driving car equipped with the drive unit according to the present invention is also able to travel on route sections that have no (external) energy supply via a conductor rail or a similar device on the support structure for cost-related reasons, for instance, or which allow such a current supply, e.g., in the area of the conventional track switch elements, only at a relatively great outlay for construction-related reasons. In the event of a temporary defect or failure of an external energy supply for the drive unit, an operation or movement of the self-driving vehicle along a driving route is enabled so that in emergency situations in which an external current supply is no longer ensured, gondolas carrying people or freight are able to head for the next station, for example, using their own drive or their own energy supply so that persons are able to disembark.

The drive unit for self-driving vehicles according to an example embodiment of the present invention provides that the drive unit has at least one battery, which is disposed inside the drive unit and installed between the at least one electric motor and the at least one contact element of the first energy supply, and/or that a second energy supply for driving at least one electric motor is available in addition, the second energy supply including at least one battery situated inside the drive unit, and the at least one electric motor being able to be brought into direct contact with the at least one contact element of the first energy supply and with the at least one battery of the second energy supply.

In other words, two basic embodiments of a drive unit are provided, which are characterized in that the drive unit has at least one battery in each case. The at least one battery is either simply used as a buffer between the contact element and the electrical conductor, which means that the at least one electric motor is always driven with an interconnected battery, or a second energy supply having at least one battery is additionally provided in the drive unit, via which the electric motor will then be driven whenever a direct energy transmission from the contact element to the electric motor is impossible, especially due to a missing electrical conductor, so that the electric motor is supplied with energy from the at least one battery of the second energy supply.

In certain driving situations, for example, the first possibility offers the advantage that currents or outputs are achievable by simple means that are higher than would be possible when using an electric conductor exclusively. The second possibility has the advantage of not stressing the battery because the battery is used only when needed.

The drive unit of an example embodiment of the present invention additionally has a second energy supply for driving the at least one electric motor, and that the second energy supply includes at least one battery situated in the drive unit. Within the framework of the present invention, a battery particularly means a rechargeable battery.

Advantageous further developments of the drive unit for a self-driving vehicle of an elevated-track type support structure are disclosed herein.

According to an example embodiment of the present invention, it is especially preferred if the at least one battery is rechargeable with the aid of a charging device, the charging device being developed to interact at least indirectly with the electrical conductor on the support structure. This offers the advantage that recharging or buffering of the battery takes place whenever an energy supply of the drive unit is implemented via the electrical conductor on the support structure. This ensures an uninterrupted availability for driving the self-driving vehicle or drive unit with the aid of the second energy supply (the internal battery in the drive unit). More specifically, no recharging of the drive unit at a stationary charging station, e.g., cyclically or at a correspondingly low state of charge of the battery, that prevents the use of the self-driving car during this period is required.

Another advantageous example embodiment of the present invention provides that the drive unit is equipped with a plurality of electric motors, in particular two motors, which interact with different drive elements of the drive unit, each electric motor being buffered or driven via at least one battery of their own. The batteries in turn are rechargeable by separate charging devices via the electrical conductor on the support structure. This offers the advantage of allowing for a redundant and an especially reliable energy supply even if one of the electric motors or its battery malfunctions.

According to an example embodiment of the present invention, it is furthermore particularly advantageous if detection means (i.e., detector(s)) are provided, which are designed to detect a presence of the electrical conductor on the support structure at least indirectly. Such detection means, especially in conjunction with switching means (i.e., switch(es)) that switch the at least one electric motor of the drive unit to establish an active connection to at least one of the two energy supplies if required, make it possible to induce a timely switchover between the energy supplies should this become necessary.

There are also different possibilities with regard to the contact element that establishes the connection between the at least one electric motor of the first energy supply and the electrical conductor on the support structure. In a first constructive example embodiment of the present invention, it is provided that the at least one contact element of the first energy supply is developed as a mechanical current collector. Such a current collector, for example, is able to be brought into contact with the electrical conductor on the support structure or be separated therefrom by appropriate adjustment means, for instance in order to avoid damage to the current collector on route sections where no electrical conductor is provided.

As an alternative, it is also possible to develop the at least one contact element of the first energy supply as a contact element that operates to provide an inductive energy transmission. Thus, the energy transmission is implemented in a mechanically contactless and also wear-free manner.

The present invention furthermore includes a self-driving vehicle for an elevated-track-type support structure having an above-described drive unit according to the present invention and a gondola which is connected to the drive unit.

The present invention also includes a support structure for drive units developed according to the present invention, the support structure having a support device, in particular in the form of at least one support rail or a support cable for establishing a driving route or route section along which a self-driving vehicle is movable with the aid of its drive unit according to the present invention; in addition, an electrical conductor is situated on the support device, which interacts with the contact element of the first energy supply of the drive unit. The support structure according to the present invention is characterized in that the driving route includes at least one route section where no electrical conductor is available.

In a further refinement of such a support structure of the present invention, identification means (i.e., identifiers) are provided along the driving route or the route section in order to mark route sections that include an electrical conductor and/or route sections that do not include an electrical conductor, and to ensure that the detection means of the drive unit are able to detect the identification means.

Finally, the present invention also encompasses a transport system, which has a support structure as described above and a drive unit developed according to the present invention or a corresponding self-driving vehicle. According to an example embodiment of the present invention, the transport system is characterized in that the identification means on the driving route or route section and/or the detection means on the drive unit are situated or developed in such a way that a steady energy supply of the at least one electric motor of the drive unit takes place with the aid of at least one of the two electric supplies. This means, for instance, that a corresponding identification means is placed just before the end of a route section of the driving route provided with an electrical conductor is reached so that when the detection means of the drive unit detects the identification means, there is sufficient time to switch from the (external) first energy supply to the (internal) second energy supply to thereby enable an uninterrupted, in particular jerk-free operation of the self-driving vehicle.

Additional advantages, features and details of the present invention result from the following description of preferred embodiments and on the basis of the figures.

### BRIEF DESCRIPTION OF THE DRAWINGS

FIG. 1 shows a simplified cross-section in the region of a support structure of a transport system, which has two driving routes for self-driving vehicles having gondolas, the driving routes extending parallel to one another.

FIG. 2 shows simplified top view of a subregion of a route network of the transport system, according to an example embodiment of the present invention.

FIG. 3 through FIG. 5 shows in simplified representations in each case, differently developed drive units for a self-driving vehicle having two separate energy supplies for driving the drive units or the self-driving vehicles, according to example embodiments of the present invention.

### DETAILED DESCRIPTION OF EXAMPLE EMBODIMENTS

Identical elements or elements having an identical function have been provided with matching reference numerals in the figures.

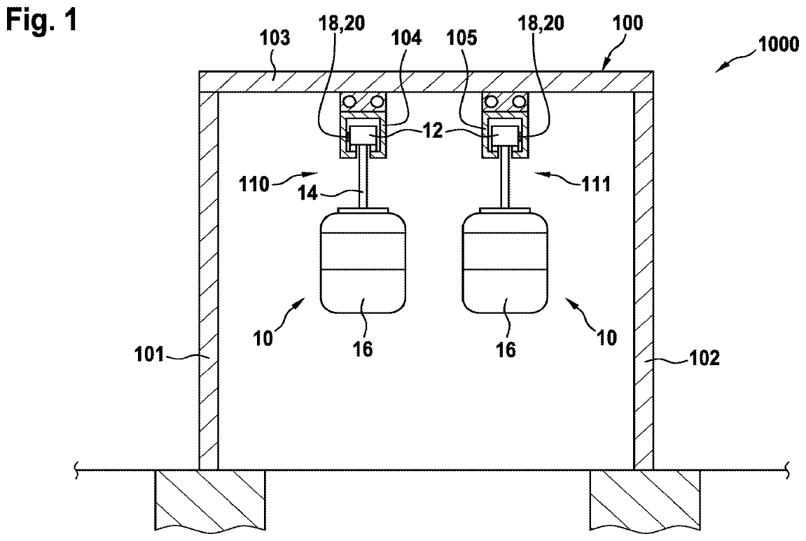

FIG. 1 shows a subregion of a transport system 1000 for self-driving vehicles 10. Transport system 1000 has an elevated track-type support structure 100, which has two pillars 101, 102 in the illustrated section of transport system 1000, which are anchored to the ground and connected to each other by a cross beam 103 by way of example. Two support rails 104, 105 situated parallel and perpendicular to the drawing plane of FIG. 1, for instance, are provided as carrier elements in the region of transverse beam 103, the support rails forming two driving routes 110, 111 situated next to each other for self-driving vehicles 10.

In addition, it is pointed out that instead of support rails 104, 105, it is also possible to provide permanently positioned support cables or similar elements along which self-driving vehicles 10 are able to be moved.

Situated within the cross-section of support rail 104, 105 is a drive unit 12 of self-driving vehicle 10, on whose underside a support arm 14, which is connected to a gondola 16, extends by way of example. For instance, gondolas 16 are shown, which are used for the transport of passengers. Within the framework of the present invention, it is naturally also possible to develop self-driving vehicles 10 or to provide them with gondolas 16 in such a way that they are suitable for transporting freight.

Also situated within the cross-section of support rails 104, 105, e.g., at the level of drive unit 12 of self-driving vehicle 10, is an electrical conductor in the form of a conductor rail 18. A conductor rail 18 describes a current-conducting element having a rectangular cross-section, in particular. Instead of an electrical conductor rail 18, the framework of the present invention naturally also includes a development of the electrical conductor in the form of an electric cable or a similar embodiment. It is only important that conductor rail 18 is part of a first energy supply 20, which constitutes an external energy supply for self-driving vehicle 10.

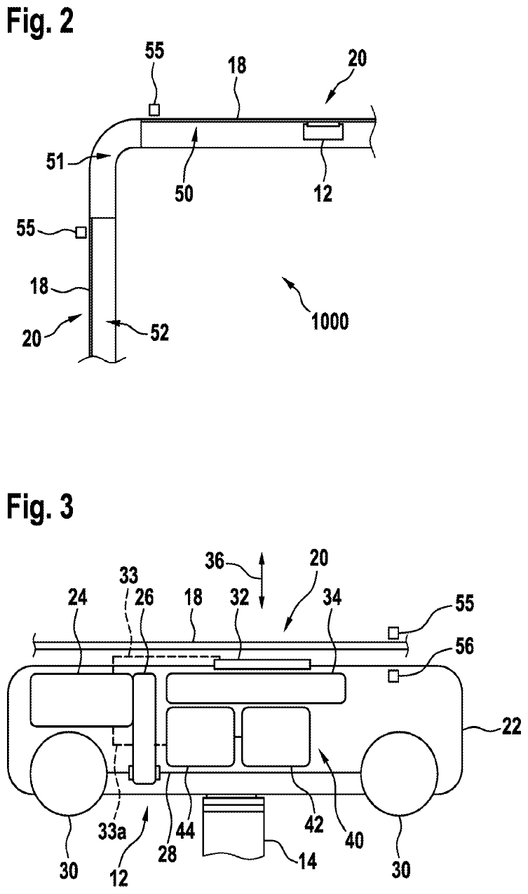

FIG. 2 shows in greatly simplified form a cutaway of a route network of transport system 1000, which has three route sections 50, 51 and 52 including support rails (not depicted in detail). While the two route sections 51 and 53 have

a straight development and form a single driving lane for self-driving vehicles 10, route section 52 is developed in the shape of a 90° arc. Essential is only that conductor rails 18 are provided on the two route sections 51 and 53 so that an energy supply of self-driving vehicles 10 via drive unit 12 is possible. In contrast, no conductor rail 18 or similar element of first energy supply 20 is provided in arc-shaped route section 52.

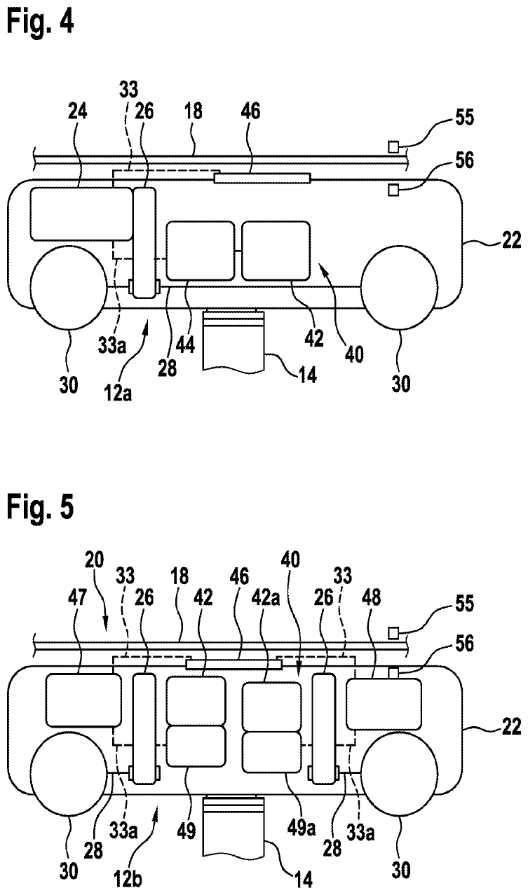

In addition, it can be gathered from FIG. 2 that identification means 55 (i.e., identifier(s)) are situated in the transition region from the two route sections 51 and 53 to route section 52, just before the respective route section 51, 53 ends, the identification means being detectable by detection means (i.e., detector(s)) 56 shown in FIGS. 3 to 5 and disposed in the region of drive unit 12 of self-driving vehicle 10. Identification means 55 and/or detection means 56 make it possible to detect (middle) route section 52 where no conductor rail 18 is provided or to infer an approach of this section before self-driving vehicle 10 reaches the region of route section 52.

FIG. 3 shows a first embodiment of drive unit 12 for self-driving vehicle 10. By way of example, drive unit 12 has a housing 22 in which an electric motor 24 used for driving self-driving vehicle 10 is situated. Via a gear unit 26, for example, electric motor 24 acts on at least one output shaft 28 which, for example, is at least indirectly connected to drive elements 30 in the form of drive rollers or similar devices, drive elements 30 being used to move self-driving vehicle 10 along support rails 104, 105 or along route sections 51 to 53. In addition, a current collector 32 can be seen, which is part of first energy supply 20, it being possible to move current collector 32 with the aid of an actuator 34 in the direction of double arrow 36 in order to bring it into mechanical and electrically conductive contact with conductor rail 18 or to separate it from conductor rail 18.

It should also be mentioned that it lies within the framework of the present invention to bring current collector 32 into contact with conductor rail 18 even without the aid of an actuator 34. For this purpose, for instance, a spring element may press current collector 32 in the direction of conductor rail 18 and a contact is always established if conductor rail 18 has a sufficiently low clearance. If no conductor rail 18 is provided, current collector 32 thus is free and has sufficient clearance from the support rail. It is then possible to provide a type of ramp for current collector 32 in the transition region to a conductor rail 18, for example, which compresses the spring element in order to subsequently allow contact to be established with conductor rail 18.

Contact between current collector 32 and conductor rail 18 always takes place in route sections 51, 53 in which transport system 1000 is equipped with conductor rails 18. On the other hand, outside such route sections 51, 53, that is, in regions where transport system 1000 or support structure 100 has no conductor rail 18, current collector 32 is preferably disposed in the position shown in FIG. 3, in which no active connection with conductor rail 18 is present.

It may be provided that electric motor 24 is directly supplied with energy via current collector 32 and conductor rail 18 of first energy supply 20, particularly in that current collector 32 is (directly) connected to electric motor 24, possibly with an interposed connection of electrical or electronic devices (not shown), which is indicated by connection 33 shown in the form of a dashed line.

In addition, drive unit 12 has within housing 22 a second energy supply 40, which allows drive unit 12 or self-driving vehicle 10 to be operated independently of first energy supply 20. Second energy supply 40, for instance, includes a charging system having a charging device 42, which is able to be brought into contact with conductor rail 18 via current collector 32 and used to charge battery 44. Similar to current collector 32, drive unit 12, battery 44 is in turn connected to electric motor 24 in a manner similar to current collector 32.

Second energy supply 40 allows for a supply of energy to self-driving vehicle 12 or electric motor 24 in the region of route sections 52 where no conductor rail 18 is provided. Because battery 44 is recharged via charging device 42 and conductor rail 18 in regions where conductor rails 18 are available, the operational readiness of second energy supply 40 is ensured at all times. A switch from first energy supply 20 to second energy supply 40 is implemented with the aid of control means (not shown), in particular when detecting route sections 52 where no conductor rails 18 are available. Such a detection particularly takes place with the aid of the mentioned identification means 55 and detection means 56.

Instead of a direct connection 33, it is also possible that electric motor 24 is always and exclusively connected to battery 44 so that an energy supply of electric motor 24 is always implemented from battery 44 or second energy supply 40. This is illustrated by dashed connection 33a. Battery 44 thus serves as a buffer.

FIG. 4 shows a drive unit 12a, which differs from drive unit 12 according to FIG. 3 in that instead of a current collector 32 as a contact element to conductor rail 18, an induction element in the form of an induction loop 46 is provided. Induction loop 46 allows for a contact-free energy transmission to conductor rail 18, which in this case is likewise developed to enable an energy transmission via the inductive route.

A drive unit 12b is finally shown in FIG. 5, which differs from drive unit 12a in that the two energy supplies 20 and 40 are developed for driving separate electric motors 47, 48 in each case, e.g., two electric motors 47, 48, which interact with different drive shafts 28 and drive elements 30 with the aid of an individual gear unit 26 in each case. The two electric motors 47, 48 are operated or supplied with energy via separate batteries 49, 49a using a separate charging device 42, 42a. Both charging devices 42, 42a of drive unit 12b are coupled with a shared induction loop 46 for the energy transmission from conductor rail 18.

It is of course also possible to provide a mechanical energy transmission from conductor rail 18 to drive element 12b, according to drive unit 12.

In addition, it should be mentioned that above-described energy supplies 20, 40 were particularly described within the framework of driving self-driving vehicles 10. It is of course understood that energy supplies 20, 40 also make it possible to enable other or additional functions of self-driving vehicles 10, e.g., to carry out braking operations, to supply heating devices in gondola 16 with energy or to supply energy to communications modules, illumination units or other devices.

Self-driving vehicles 10 or drive units 12, 12a, 12b as described above are able to be modified in many ways without deviating from the present invention.

1-11. (canceled)

12. A drive unit for a self-driving vehicle of an elevated-track-type support structure, the drive unit comprising:
at least one electric motor configured to move the drive unit along the support structure, the at least one electric motor being configured to be at least indirectly driven using a first energy supply, the first energy supply having at least one contact element which is configured to interact with an electrical conductor immovably situated on the support structure;
at least one battery disposed inside the drive unit and installed between the at least one electric motor and the at least one contact element of the first energy supply, and/or a second energy supply configured to drive the at least one electric motor, the second energy supply including at least one battery situated inside the drive unit, and the at least one electric motor is configured to be brought into direct contact with the at least one contact element of the first energy supply and with the at least one battery of the second energy supply.

13. The drive unit as recited in claim 12, wherein the at least one battery is rechargeable using a charging device, the charging device being configured to interact at least indirectly with the electrical conductor on the support structure.

14. The drive unit as recited in claim 12, wherein the first energy supply and the second energy supply interact with different electric motors, the electric motors interacting with different drive elements of the drive unit, and the electric motors are coupled with separate batteries and charging devices.

15. The drive unit as recited in claim 12, further comprising:
a detector configured to detect a presence of the electrical conductor on the support structure at least indirectly.

16. The drive unit as recited in claim 12, further comprising:
a switch configured to switch the at least one electric motor as needed to an active connection with at least one of the first and second energy supplies.

17. The drive unit as recited in claim 12, wherein the at least one contact element of the first energy supply is a mechanical current collector.

18. The drive unit as recited in claim 12, wherein the at least one contact element of the first energy supply is a contact element operating as a contact element for inductive energy transmission.

19. A self-driving vehicle, comprising:
a drive unit for a self-driving vehicle of an elevated-track-type support structure, the drive unit including:
at least one electric motor configured to move the drive unit along the support structure, the at least one electric motor being configured to be at least indirectly driven using a first energy supply, the first energy supply having at least one contact element which is configured to interact with an electrical conductor immovably situated on the support structure, and
at least one battery disposed inside the drive unit and installed between the at least one electric motor and the at least one contact element of the first energy supply, and/or a second energy supply configured to drive the at least one electric motor, the second energy supply including at least one battery situated inside the drive unit, and the at least one electric motor is configured to be brought into direct contact with the at least one contact element of the first energy supply and with the at least one battery of the second energy supply, and
a gondola, which is at least indirectly connected to the drive unit, configured to transport persons or freight.

20. A support structure for a drive unit for a self-driving vehicle of the support structure, the drive unit including:
at least one electric motor configured to move the drive unit along the support structure, the at least one electric motor being configured to be at least indirectly driven using a first energy supply, the first energy supply having at least one contact element which is configured to interact with an electrical conductor immovably situated on the support structure,
at least one battery disposed inside the drive unit and installed between the at least one electric motor and the at least one contact element of the first energy supply, and/or a second energy supply configured to drive the at least one electric motor, the second energy supply including at least one battery situated inside the drive unit, and the at least one electric motor is configured to be brought into direct contact with the at least one contact element of the first energy supply and with the at least one battery of the second energy supply,
the support structure comprising:
a support device in the form of at least one support rail or a support cable for establishing a driving route or a route section along which the drive unit is movable;
an electrical conductor at least regionally situated on the support device, which interacts with the contact element of the first energy supply of the drive unit;
wherein the driving route includes at least one route section where no electrical conductor is provided.

21. The support structure as recited in claim 20, further comprising:
identifiers for marking route sections that include an electrical conductor and/or route sections that do not include an electrical conductor, the identifiers being provided along the driving route or the route section, and the identifiers being detectable by a detector of the drive unit.

22. A transport system, comprising:
a support structure for a drive unit for a self-driving vehicle of the support structure, the support structure including
a support device in the form of at least one support rail or a support cable for establishing a driving route or a route section along which the drive unit is movable, and
an electrical conductor at least regionally situated on the support device, which interacts with a contact element of the first energy supply of the drive unit,
wherein the driving route includes at least one route section where no electrical conductor is provided;
at least one drive unit including:
at least one electric motor configured to move the drive unit along the support structure, the at least one electric motor being configured to be at least indirectly driven using a first energy supply, the first energy supply having the contact element which is configured to interact with the electrical conductor immovably situated on the support structure,
at least one battery disposed inside the drive unit and installed between the at least one electric motor and the at least one contact element of the first energy supply, and/or a second energy supply configured to drive the at least one electric motor, the second energy supply including at least one battery situated inside the drive unit, and the at least one electric motor is configured to be brought into direct contact with the at least one contact element of the first energy supply and with the at least one battery of the second energy supply;
wherein identifiers are situated along the driving route or the route section, and/or a detector is situated or developed on the drive unit in such a way that a steady supply of energy to the at least one electric motor of the drive unit is provided by at least one of the first and second energy supplies.
